(19) United States
(12) Patent Application Publication
(10) Pub. No.: US 2008/0314413 A1
(43) Pub. Date: Dec. 25, 2008

(54) Cyclone cleaning device and method

(75) Inventors: Jim P. Wetzel, Point Edward (CA); Mark E. Veysey, Petrolia (CA); Len F. Lampert, Thornhill (CA)

Correspondence Address: ExxonMobil Research & Engineering Company, P.O. Box 900, 1545 Route 22 East, Annandale, NJ, 08801-0900, US

(73) Assignee: ExxonMobil Research and Engineering Company, Annandale, NJ (US)

(21) Appl. No.: 12/081,371

(22) Filed: Apr. 15, 2008

Related U.S. Application Data
(60) Provisional application No. 60/929,276, filed on Jun. 20, 2007.

(51) Int. Cl. B08B 9/093

(52) U.S. Cl. 134/22.18; 134/157

(57) ABSTRACT

A process vessel cleaning tool comprises a metal tube which can be introduced through an insertion port and sealing assembly into a high temperature process vessel. The metal tube supplies liquid under pressure to a cleaning tool head located at the leading end of the metal tube. The tool head is of generally cylindrical form and has a rolling contact element such as a roller, wheel or ball caster; which is axially displaced a short distance from a rotary jet nozzle head. The rolling contact element permits the tool head to pass readily over rough surfaces in the cyclone passages e.g. over Hexmesh™ and refractory or weld seams and around changes in direction in the snouts and diplegs of the cyclones within the process vessel. The metal tube with its unique tool head design is capable of being introduced into the cyclone while it is in operation, thus enabling considerable economies to be effected. As well as in cyclones, the tool may be used to clean the interiors of other process vessels and associated piping. The metal tube is introduced into the process vessel through a port and sealing assembly in the vessel wall which permits the metal tube to be advanced progressively into the vessel by a suitable drive mechanism without substantial leakage of gases from the vessel.

### CROSS REFERENCE TO RELATED APPLICATIONS

This application relates to and claims priority to U.S. Provisional Patent Application No. 60/929,276, entitled “Cyclone Cleaning Device and Method,” filed on Jun. 20, 2007.

### FIELD OF THE INVENTION

This invention relates to a device for cleaning cyclones and to a method for carrying out the cleaning while the cyclone is in operation.

### BACKGROUND OF THE INVENTION

Hydrocarbon cracking operations such as fluid catalytic cracking and fluid coking in which hot hydrocarbon gases need to be separated from small, fluidized, solid particles usually use cyclones to separate the particles from the gas. In the high temperature, erosive environment of these operations, the cyclones are normally made of steel and lined with refractory, erosion-resistant materials such as refractory monoliths, brick or tiles. Resistance to high temperatures and erosion is not, however, the only service requirement. The vapors leaving the hot reaction zone are at or near their dew or condensation point and they tend to condense on cooler surfaces—such as the vapor lines or conduits which conduct the vapors from the reaction zone to the separator cyclones and from the cyclones to downstream equipment such as fractionators. The condensation results in a substantial build-up of coke, which is formed from the cracking of hydrocarbons and is often very adherent and difficult to remove. This condensation and subsequent coke deposition is particularly serious on surfaces having temperatures in the range of about 350° to 600° C. (about 700° to 1,100° F.). Eventually, the coke deposits seriously restrict the flow of hydrocarbon vapors from the cyclone, causing a number of problems including: increases in the pressure in the cyclone and the preceding reaction zone; a reduction in cyclone efficiency; and excessive losses of fine particles that are normally retained within the equipment. Consequently, the unit must be shutdown for removal of the coke deposits from the cyclone

In fluid coking units, one proposed solution has been to inject finely divided hot coke particles into the dispersed phase to prevent coke deposition and condensation by heating the vapors and scouring deposited coke from the cyclone. This method has been used extensively. However, it has proved to be difficult to operate and has not been entirely successful in eliminating coke deposition in the cyclone gas outlet because the particles are removed—as they are intended to be—in the cyclone. Other methods which do not require the process unit to be shut down have been proposed. U.S. Pat. No. 2,934,489, for example, describes a method in which a small amount of oxygen-containing gas is injected into the cyclone so as to combust a portion of the product vapors for the purpose of raising the temperature of the inner surfaces of the discharge lines so that coke deposition is prevented. This procedure is not desirable since products of combustion enter the hydrocarbon vapor stream. U.S. Pat. No. 2,326,525 proposes the use of a plunger equipped with rotating spray nozzles through the buildup of material in the conduits while spraying oil under high pressures to carry tarry materials away and break off hardened coke. This method, however, tends to disrupt proper cyclone and reactor operation when the resulting large quantities of vapor are formed in the conduits.

Lancing is a method of cleaning that has been practiced for many years. Lancing involves the insertion of a metal pipe or a metal tube into a process vessel at a location where the foulant or debris has accumulated. When the process vessel is operating at elevated pressure and temperature conditions, the lance is inserted through a sealing assembly to prevent leakage of the process fluids to the environment. The lance can be used to physically remove the foulant or debris. Alternatively, an external fluid such as steam or water can be injected through the lance to carry out the task. Once the foulant or debris has been loosened and moved, it can be carried by the process fluids to a location where it can be removed or otherwise handled.

Simple lancing with a straight metal pipe or tube may be used to remove foulant from the cyclone gas outlet pipes with a straight pipe run. The need for a straight pipe run is, however, severely limiting since the locations that are accessible with a straight lance represent only a fraction of the total area that needs to be cleaned.

Canadian Patent Application No. 2 397 509 describes a method for cleaning a coker vessel which uses a nozzle mounted on the end of a flexible conduit that is introduced into the vessel through a port in the vessel wall which seals around the flexible conduit so as to preclude significant gas losses while the flexible conduit is in the vessel. A pressurized liquid is fed through the flexible conduit and it passes out as liquid jets through a nozzle with the intention of disrupting the accumulated coke on the vessel wall. The conduit is progressively advanced into the vessel by means of a drive or injector assembly comprised of two opposed gripper tracks so that the entire length of the conduit can be exposed to the liquid blast from the nozzle. This device is said to be capable of insertion through the wall of a fluid coker unit and into the snouts and diplegs of the coker cyclones. This method has demonstrated limited improvement because it is not very effective in removing the foulant from the full circumference of the gas outlet pipe. In addition, the drive force needed to push the lance through constricted and tortuous flow passages such as cyclone snouts has a propensity to buckle the lance and has severely limited travel of the lance and the removal of foulant from the lower half of the gas outlet pipe as well as in cyclone diplegs.

### SUMMARY OF THE INVENTION

The present invention provides a cleaning device and method which enables fouled cyclones, including the gas outlet snouts and diplegs to be cleaned more effectively. This device includes, a unique cleaning tool head that is capable of being introduced into the cyclone while it is in operation, thus enabling considerable economies to be effected. This device and method may be used to clean the interiors of cyclones and other process vessels and associated piping.

The cleaning tool comprises a metal tube which can be introduced through an insertion port into a high temperature process vessel. The tubing has the purpose of supplying liquid under pressure to the cleaning tool head while it is in a cyclone or any other process vessel or passage to be cleaned. Coupled to the leading end of the metal tubing is a cleaning tool head which receives the liquid from the tubing. The tool head is of generally cylindrical form with a rolling contact element which is axially displaced along the length of the tool head from a rotary jet nozzle head. The rolling contact element has the purpose of permitting the end of the tool head to pass readily over rough surfaces (e.g., over Hexmesh™) and refractory or weld seams and around corners in the snouts and diplegs of the process vessel by minimizing frictional resistance. This rolling contact element may be one or more rollers, wheels and/or ball casters mounted on a swivel axle so as to permit rolling contact regardless of the orientation of the tool head with respect to the direction of the movement of the tool head. In addition, the rolling contact element preferably contains jets for the passage of a liquid to remove foulant from the rolling path ahead of the nozzle. The rotary jet nozzle head allows jets of a cleaning liquid (preferably, water but optionally oil or another liquid) to be forced out from the nozzles in the nozzle head, to impinge upon the fouled walls of the cyclone components and, thereby, remove foulant deposits by mechanical action. The rotary jet nozzle suitably comprises a rotatable nozzle head with a plurality of liquid jet outlets arranged around its circumference to give radially uniform foulant removal.

When used with a process vessel which is in operation, the cyclone cleaning tool is introduced through a port in the process vessel which permits the metal tube to be advanced progressively into the vessel without substantial leakage of process gases. Simultaneously, cleaning liquid is fed under high pressure to the cleaning tool head on the end of the tube. A suitable device such as a packer or sealing gland around the tubing at the vessel wall provides the requisite sealing. A drive assembly grips the tubing and moves it forward into and through the constricted interiors of the vessel. The tube is withdrawn by reversal of the drive direction.

Also described herein is an improved method of cleaning fouled cyclones and other constricted equipment, including especially cyclone diplegs, with a metal tube such as the one described above. A tube, suitably made of steel, is connected to a supply of pressurized cleaning liquid which passes along the tubing to a cleaning tool head on the free end of the tubing. The metal tube properties are such that the tube can be plastically deformed to achieve a change in direction, but also maintain sufficient rigidity to continue with forward penetration without further plastic deformation after the change in direction has been achieved. To enable the tube and its associated cleaning head to progress into the cyclone and the diplegs, a permanent deformation is imparted on the tube as it penetrates beyond the initial change in direction of the cyclone. The method uses the permanent deformation in conjunction with the rolling element to minimize the frictional resistance at the contact points and allow the tube to continue penetrating the cyclone without buckling. There is a narrow window for the applied thrust to allow continued penetration without initiating buckling of the tube which prevents further travel into the cyclone and dipleg. Continued application with the same tube requires consideration of the cycle life of the tube as limited by fatigue. It has been found that it is desirable to induce a C-curve in the tube so as to facilitate travel of the tube down into the cyclone barrel and, when necessary, into the dipleg. The optimal curvature may be determined empirically on the actual equipment: either an excessive curve or an insufficient one will make it difficult or even impossible for the tool to enter the parts of the cyclone which require cleaning.

### DRAWINGS

In the accompanying drawings:

FIG. 1 is a simplified schematic illustrating one embodiment of the present cleaning tool in use in a representative cyclone of a fluid coker unit;

FIG. 2 is a more detailed representation of the head of the cleaning tool illustrated in FIG. 1;

FIG. 3 is a longitudinal cross section of the head of a cleaning tool; and

FIGS. 4a and 4b are sectional views of the rolling contact end of the head of the cleaning tool illustrated in FIG. 3.

### DETAILED DESCRIPTION

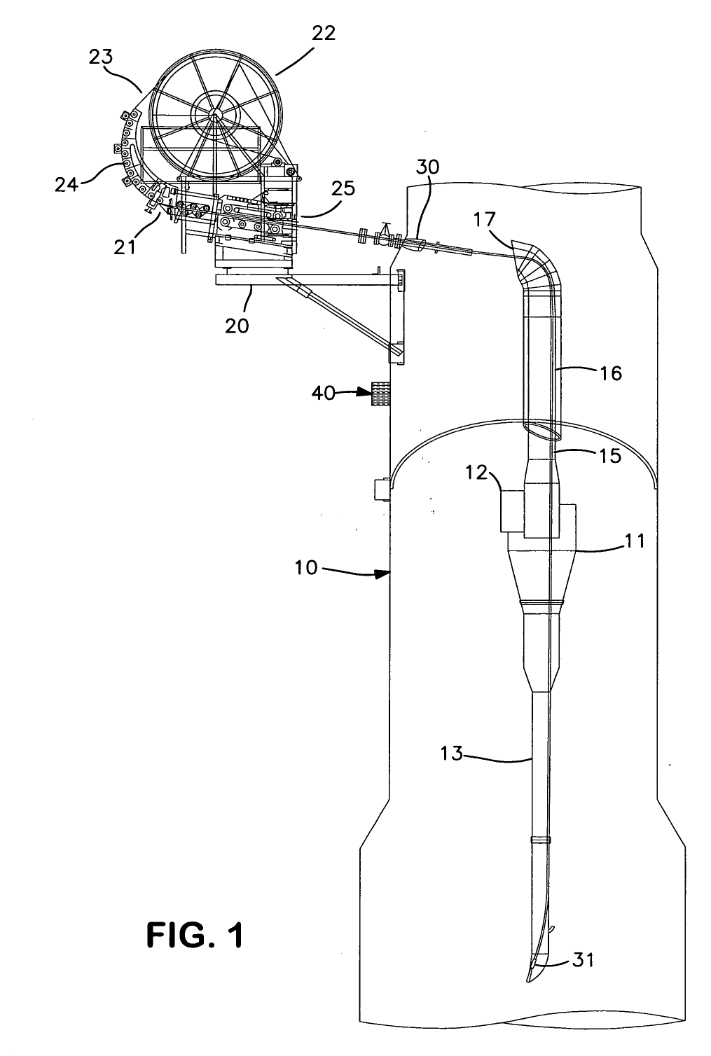

FIG. 1 shows one embodiment of the cleaning device as it operates to clean a representative cyclone in a process vessel 10 of a fluid coker unit. In FIG. 1, a process vessel 10 of a fluid coking unit has a cyclone described by its component parts. The component parts of the cyclone include a cyclone barrel 11, a cyclone inlet 12, a cyclone dipleg 13 and a gas outlet conduit 15. The cyclone barrel 11 is used to separate fine coke particles from the hot gases from the coking reactor 10 entering by way of cyclone inlet 12. Cyclone dipleg 13 descends from the bottom of the cyclone barrel 11 to return separated coke particles to the remainder of the process unit, in this case, the burner vessel which provides process heat. The gas outlet conduit 15 of the cyclone passes up through an encircling shroud pipe 16. The top of gas outlet conduit 15 curves over into a snout 17 which faces outwards towards the wall of the process vessel 10.

In FIG. 1, the cleaning device is also shown by its component parts. More specifically, supported on the outside of the process vessel 10 is a platform 20 which supports a tube coil and drive mechanism indicated generally at 21. The tube coil and drive mechanism 21 includes a coil of tubing 23 on a tubing drum 22 mounted on trunnions on the supporting framework in the conventional manner. Coiled metal tubing, as used in the upstream drilling and production industry, or any equivalent tubing, can be used as the metal tube 23. A combination of small diameter, thin wall and high yield strength will provide the necessary combination of flexibility to minimize the force required to change the travel direction, while still providing adequate rigidity to resist deformation by buckling under the applied drive force. These tubing parameters can be determined in accordance with service requirements but in the applications tested the following have been found to be adequate for fluid coker cyclone service and would be typical for this and similar service:

Tubing material: Steel, ASTM A606 Type 4 modified

Tubing diameter: 25-30 mm (about 1-1.25 inch).

Tubing wall thickness: 2-3.5 mm (about 0.087-0.125 inch).

Tubing material yield strength: 500-800 MPa (about 72-116 Kpsi)

In addition, the tubing properties allow the use of high liquid pressures in the range of 500 to 1000 barg (approximately 7000 to 15000 psig) to provide effective removal of foulant deposits from the cyclone elements. Tubing properties must be sufficient to resist buckling over the unsupported lengths as the tube extends without support between insertion port 30 and snout opening 17, as well as gas outlet conduit 15 and cyclone body 11.

The metal tube 23 is unwound from the drum 22 and passes through guide rollers 24 and mandrels 21a to drive mechanism 25 which comprises a pair of opposed chains with tube gripper blocks which can be actuated by independent drive motors (not shown) to provide the desired rate of tube advance and withdrawal. Control mechanisms (not shown) for the drive mechanism 25 provide for tubing 23 advance and withdrawal. The drive motor may be electric or hydraulic, as convenient. An example of a suitable tubing drive mechanism 25 is given in U.S. Patent Application No. 2002/0046833. Alternative drive mechanisms 25 may be used, for example, utilizing grip rolls instead of blocks—although the use of the gripper blocks is preferred since it allows lower gripping forces to be used while still maintaining a net effective drive force. Mandrels 21a may be used to impart a permanent deformation on the metal tube. Directional control of the cleaning tool head may be achieved by using the mandrels to impart an upward or downward curvature on the metal tube and when operating in curved cyclone snouts as shown in FIG. 1, it is usually preferable to impart an initial curvature on the tube so as to guide it through the curved portion of the snout and permit it to travel more easily into the barrel. In addition, the mandrels may be used to assist with coiling of the tube onto the reel during retraction and removing the deformation from the tube upon removal from the reel.

The drive mechanism 25 is mounted on a pivot point (not separately indicated) with a load cell positioned between the drive mechanism and the main frame to provide an indication of the force being applied to the metal tube 23 from the measured reaction between the drive mechanism and the main frame. The cleaning head 31 followed by the tube 23 enters process vessel 10 through insertion port 30 which provides a pressure tight seal with the tube 23 as it advances. The port 30 will typically have a packer or stuffing box to prevent leakage of fluid from the interior of the process vessel 10 through the gap around the tube 23. Couplers and shutoff valves may be provided as required for operational and safety purposes. A suitable insertion port is shown in Canadian Patent Application No. 2 397 509.

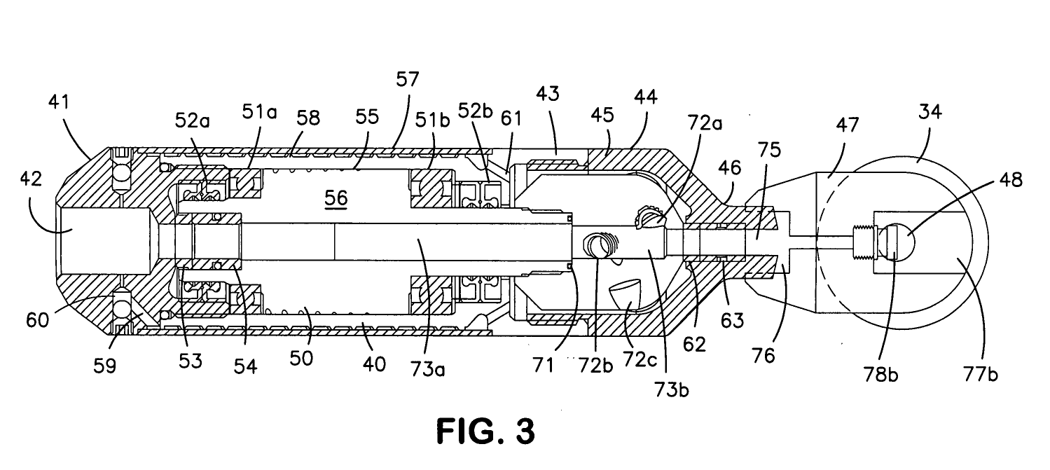

When cyclone snout 17, cyclone barrel 11 and cyclone dipleg 13 are to be cleaned, the metal tube 23 is advanced by the drive mechanism 25 so that the cleaning tool head 31 enters the snout 17 and passes down the gas outlet conduit 15. The cleaning tool head 31 shown in FIG. 1 contains a nozzle with rotary spray jets 36, an elongated spacer member 35 and a rolling contact element 34 with axial spray jets. A more detailed cross sectional view of the nozzle is shown in FIG. 3, described below. Liquid under high pressure is fed into the metal tube 23 through a connection on the tubing drum 22 to remove the foulant by physical impact of the liquid jets on the deposits. The tool head 31 is advanced as deposit removal proceeds in both the axial and circumferential directions, permitting the deposits to be removed progressively along the length of the cyclone. As shown in FIG. 1, the tool head 31 can be introduced into the cyclone dipleg 13 to the bottom to remove the deposits which accumulate there. A rolling contact element (not shown in FIG. 1) on the end of the tool head 31 facilitates entry of the tool and its associated tube 23 into the constricted spaces of the cyclone 11 and around the corners and bends in the snout 17 and the dipleg 13 and contributes materially to the ability to carry out cleaning while maintaining normal or near-normal process operation in the process unit. The effectiveness of the cleaning can ultimately be determined by gross measurements of cyclone pressure drop and cyclone efficiency but in order to provide a real time indication of the progress of the cleaning, an acoustic monitoring technique may also be used. An accelerometer 40 mounted on the shell of process vessel 10 can be used to detect the sound of foulant removal, impingement and the rotation of the nozzle on the tool head 31 Acoustic monitoring allows more precise control of the tube 23 while inside the process vessel 10. By listening to the acoustics, the position of the tool head 31 can be estimated. The spray from rotating jets can be heard striking the interior surfaces of the process vessel 10 while the nozzle on the tool head 31 is outside of the snout 17. Upon entry into the snout 17, the water jets will no longer be heard striking the interior surfaces of the process vessel 10 but nozzle rotation can still be heard through the metal tube.

Suitable types of acoustic monitoring methods which may be adapted to the present purpose are disclosed, for example, in U.S. Pat. Nos. 5,675,071; 5,652,145; 5,218,871; 5,207,107; 5,193,406. The monitor outputs can be correlated empirically with pressure drop measurements to determine optimal operational parameters and techniques.

Although, as described below, it may be desirable to confer directional control over the tool head 31 by advancing the tube 23 in a forceful manner to impart a permanent set on the tool head end of the tube 23, it is also important to maintain the drive force on the tube 23 at a value which does not cause buckling and flattening of the tube 23, for example, when the tube 23 is passing round a corner or into a more constricted conduit, e.g. into a dipleg 13 from the barrel 11 of the cyclone. In order to monitor the driving force being applied by the drive mechanism 25, load cells located between the driving mechanism 25 and the main frame measure the thrust imparted by the drive tracks to the tube 23. The force monitored by the load cells can be transmitted to provide an indication on the operating console so that the operator can stop the drive if the thrust is likely to cause buckling or possible damage to the cyclone snout 17 assembly. Equally, as described below, the drive force can be increased to the point where the tube 23 acquires a permanent set but short of buckling. Data from electronic load cells (not shown) can be plotted in real time and used to determine when the maximum safe force has been applied. The load cells are also used to ensure that the applied force does not exceed the maximum permissible force on the snout 17 assembly. Exceeding this force could result in failure of the attachment weld, which would require an immediate process unit shutdown.

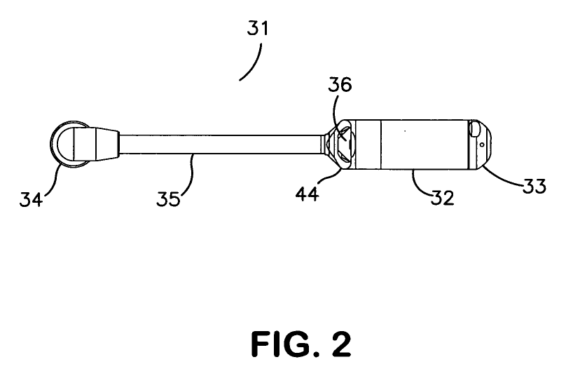

FIG. 2 shows the general configuration of the cleaning tool head 31 which is attached to the inward end of the tube 23 and which jets the high pressure fluid onto the interior walls of the cyclone snout 17, barrel 11 and dipleg 13 to remove the foulant deposits; a detailed sectional view of a cleaning tool head similar to that of tool head 31 is shown in FIG. 3 but in that case, the spacer element 35 is omitted for a shorter separation between the rolling contact element and the rotary cleaning jets. Referring to FIG. 2, the cleaning tool head 31 is elongated and generally cylindrical in form (circular in cross section with a central axis) and comprises a main body member 32 which is secured to the end of tube 23 by means of a fluid tight coupling 33 at one end of the cleaning tool head 31. At the other or front end of the cleaning tool head 31 is a rolling contact element (in this case a roller 34) journalled on a transverse axle to permit free rotation of the roller 34 to provide the desired rolling contact with the interior walls of the cyclone components when the tool head 31 comes into contact with the walls. The tool head is equipped with a rotary nozzle head with multiple, substantially radial cleaning jets to remove foulant; in addition, one or more generally axially-oriented jets are preferably used to maintain a clear path ahead of the rolling contact element. The axle of roller 34 may be mounted in a housing 35 which is axially rotatable with respect to the central axis of the main portion of cleaning tool head 31. In this way, rolling contact will be allowed regardless of the direction of tool head movement when it comes into contact with the walls of the cyclone components. The diameter of the roller 34 should preferably be at least 50 mm for proper operation. As noted above, the rolling contact element may alternatively be provided by a large ball caster (ball diameter comparable to roller diameter) which permits rolling contact in any direction. A ball caster may be fabricated by machining or swaging a tube member constituting the housing on the end of the tool head so as to retain the ball inside the housing with a spring in the barrel of the housing to urge the ball against the open end of the housing with a ball follower ring between the ball and the end of the spring to transfer spring force to the ball while permitting rotation of the ball.

The rolling contact element (e.g., roller 34) is located a short distance in front (in the direction of tool head 31 advance) of a nozzle head 36 so that the rolling contact element provides centering capability for the nozzle head 36, the desired separation being provided by axially elongated spacer member 35. Suitably, a separation of about 250 to 600 mm. will suffice without, at the same time, making the tool too long to go around corners in the cyclone snouts and diplegs although different lengths may be used for equipment items of different sizes and, as shown in FIG. 3, the spacer member may be omitted entirely if the construction of the head provides adequate separation between the rolling contact element and the cleaning jets. Additional spacers of various lengths can be installed between the rolling element 34 and the nozzle head 36 to change the position of rotating jets relative to the surface of the cyclone 11. This allows optimization of the nozzle position within the cyclone. Differing spacer lengths may be used at different points in the cleaning process. For example, a spacer giving a separation of about 30 cm. between the wheel and the rotary nozzle jets is normally appropriate for cleaning the upper portion of the cyclone but if the dipleg has to be cleaned, a shorter separation is normally desirable and this can be achieved by using the tool without the spacer element.

The radial liquid jets required to remove foulant from the entire circumference of the cyclone components are provided by a rotary nozzle head 36 mounted in the main body 32 of the tool head. The rotary nozzle head 36 is mounted on body member 32 which also has a threaded boss (not shown) retaining spacer 35 by means of a correspondingly threaded recess in the spacer. The rotary nozzle head 36 is provided with internal liquid passageways to receive the high pressure cleaning liquid which passes down through the tube 23 to the interior of the tool head 31 and then, by way of the internal fluid flow passages to the rotary nozzle head 36 and through an additional high-pressure seal and elongated spacer member 35 to the rolling contact element 34. Sealing between the rotating portions of the rotary nozzle head 36 and the stationary main body 32 of the tool head 31 is provided by opposing double-lip seals, which are cooled by means of an internal cooling jacket through which the cleaning liquid flows on its way to the rotary nozzle head 36 from the tube 23. An internal viscous fluid governor is used to maintain a slow rotational speed for the nozzle head (e.g. 10 to 100 rpm).

A cross section of the cleaning tool head is shown in FIG. 3 to illustrate the internal mechanical construction of this embodiment. As shown in FIG. 3, the cleaning tool head is the same as that of tool head 31 of FIG. 2 but in this case, is shown without the spacer member 35 so that the rolling contact wheel 34 is fixed relatively close to the rotary nozzle head 36. The tool head comprises a body member 40 which is screwed into end casting 41 which has an internally screwed socket 42 (screw threads not shown for clarity) for receiving an externally threaded connector on the end of the flexible tubing (not shown). A lock nut or tack weld on the connector may be used to prevent unintentional unthreading of the tool head from the tube. The distal end of the body member 40 has a larger, internally-threaded receptacle 43 into which end cap 44 is screwed. End cap 44 is formed with two longitudinally extending support members fabricated with material of sufficient strength to withstand the forces applied to the nozzle as it travels through the cyclone, extending forward from the main boss portion 45, separated by enlarged slots through which the water jets from the rotary nozzle head 36 pass when the tool is in operation (as seen in FIG. 2). The two support members carry at their distal ends a centrally bored end boss 46 which is externally screwed to carry the end of the first spacer member (when present) or, in the case of the FIG. 3 embodiment, wheel housing 47 supporting the rolling contact wheel 34 journalled on transverse axle 48.

A centrally bored shaft 50 is mounted internally within body 40 on bearings 51a, 51b with opposing double-lip seals 52a, 52b providing bi-directional liquid sealing. At the end proximate to the water inlet provided by socket 42, shaft 50 runs on support seat 53 with sealing being provided by means of the o-ring retained within high pressure seal 54. At the distal end, shaft 50 runs in seat 62 sealing being provided by means of the o-ring retained within the high pressure seal 63. A number of peripheral grooves 55 run around the enlarged portion 56 of the shaft 50. These grooves 55 are filled with a viscous fluid to act as a governor for control of the rotational speed of the shaft 50 as noted above. The viscous fluid is retained by means of opposing double-lip seals 52a and 52b. A sleeve 57 covers a portion of body member 40 to define a cooling jacket in the region between the sleeve and the body member 40 of the tool head with clearance between the sleeve 57 and the body maintained by means of spiral ribs 58 on the outside of the body member 40. Cooling water enters the jacket from socket 42 by way of drilled passageways one of which is indicated at 59, fed from gallery 60 which communicates with the interior of socket 42 where the water enters from the tube. The cooling water leaves the jacket by way of passageway 61 at the distal end of the tool head and passes to the outside of the cleaning tool head just behind the nozzle head.

A rotary jet nozzle head 70 is screwed onto the end of shaft 50 with an intervening o-ring seal 71; since rotation is only in one direction, no keying needs to be provided although a flat machined onto the shaft 50 with a U-clip passing through slots in the head 70 can be used to preclude rotation between the head 70 and the shaft 50. Three nozzle ports 72a, 72b, and 72c are set into the nozzle head 70 with their flow passages in communication with the bore 73a of shaft 50 and the central bore 73b of nozzle head 70. The nozzle ports 72a, 72b, and 72c are arranged at the angular dispositions discussed below to provide the desired action when the tool is in operation, rotation of the nozzle head 70 being provided by the tangential thrust of the radial water jets emerging from the nozzle jets 72a, 72b and 72c. Nozzle inserts with differing orifice sizes may be threaded into nozzle ports 72a, 72b, and 72c to obtain the desired flow rate, rotational speed, and cleaning tool vibration.

The nozzle ports allow radial jets of cleaning liquid to exit the nozzle head 36 forcefully for foulant deposit removal. The nozzle apertures are offset tangentially to provide torque for rotation. In addition, a degree of imbalance is preferably incorporated so the entire tool head 31 will oscillate. For this purpose, the nozzle apertures may be given a controlled departure from the true plane transverse to the axis of the tool head. For example, the opposing forces may be designed to be unequal either in terms of flow rate or jet angle—the jet flow rate or jet angles are designed to be slightly different to cause the entire tool head 31 to jump around as this has been found helpful in navigating the cleaning tool head 31 past obstructions. This oscillating vibration further reduces friction between the rolling element 34 and the cyclone surfaces with which it is in contact and the metal tube and the cyclone surfaces, facilitating travel of the cleaning head 31 with a lower applied driving force. The number of nozzle apertures is preferably minimized (i.e. 2 or 3 holes) to provide the strongest impact energy from the jets with a limited volume of liquid. For maximum effectiveness in deposit removal, the jets are oriented substantially perpendicular to the surface of the foulant, i.e. substantially perpendicular to the walls of the conduit (radial to the wall at the point of contact and radial to the axis of the tool head), although retaining a tangential component to induce rotation of the nozzle head 36. We have found that the optimal jet angle is in the range of 65° to 115° relative to the axis of the tool head 31 (i.e. within 25° of the rotational plane of the nozzles which for these purposes is considered substantially radial). The nozzle apertures may be arranged at different angles on either side of the plane of rotation of the nozzle head 36 so that no substantial net axial force on the head 36 is created by the jets; if the number of jets is not even, the jets may be placed at different angles in such a manner that the resultant axial force on the tool is zero. For example, assuming the jets have equal flow rates at the selected operating pressure, one jet oriented towards the front of the tool at an angle of 60° to the longitudinal tool head 31 axis will be approximately balanced in terms of axial thrust by two backwards facing jets on opposite sides of the nozzle head 36, each at an angle of about 76° to the tool axis; similarly two forward facing jets at an angle of 70° each to the tool axis could be approximately balanced by three jets each at an angle of about 72° to the tool axis. Clearly, other combinations of angles and numbers of jets and jet strengths can be combined to neutralize the axial thrust load on the tool head 31 but when the nozzle apertures are within the preferred angular disposition at no more than 25° from the rotational plane of the nozzle head 36, the axial thrust generated is not likely to be great and detailed calculation of the angles is not required. It is not necessary to have a complete neutral thrust balance although it may be useful in assisting the tool head 31 to enter the tight spaces within cyclones and other equipment.

Flow rates of the cleaning fluid, usually water, will be chosen according to the character of the foulant deposits with harder, more adherent deposits requiring the more vigorous action of high flow rates to be used. Also, the size of the tool head 31 and of the equipment to be cleaned will factor into the selected flow rate. Using a tool head 31 of about 50 mm. diameter to clean cyclones with gas outlet tubes of about 500 mm. diameter, we have found flow rates of about 250 to 300 litres/minute (about 66 to 80 gpm) to be adequate.

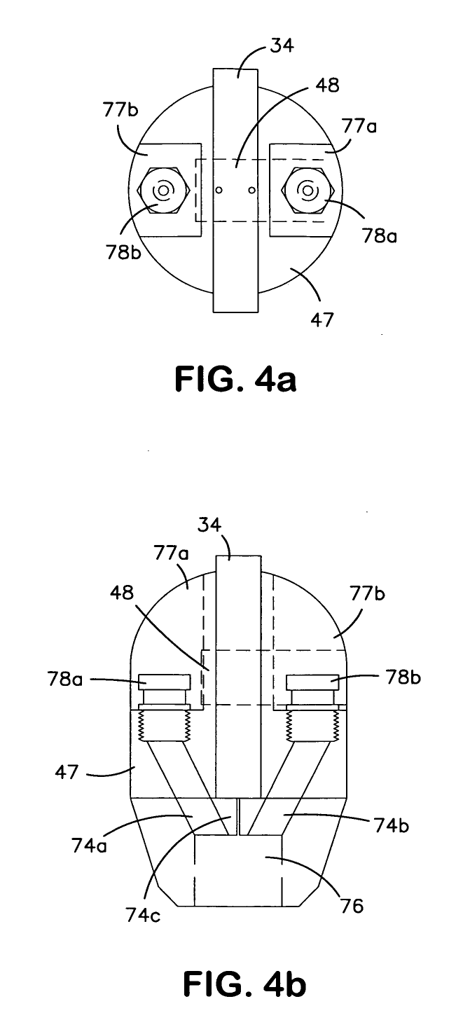

In order to clear the way ahead of the tool head and to prevent the wheel 34 becoming jammed with debris from the cleaning operation, the interior of wheel housing 47 has three liquid flow passageways 74a, 74b, 74c (best seen in FIG. 4b) which communicate with the open ended bore 75 of central boss 46 to permit the flow of water to substantially forward-facing jet nozzle ports 79a and 79b in wheel housing 47. Two passageways, 74a, 74b, extend from the central, internally-threaded recess 76 in the wheel housing 47 to jet nozzle inserts 78a, 78b, suitably of the same type used in rotary nozzle head 70. These nozzle ports are located in slots 77a, 77b milled into the two opposite sides of wheel housing 47 and are screwed into body 47. Transverse axle 48 for wheel 34 is pressed into a hole in body 47 to retain wheel 34 and after insertion, the hole should be weld restored and machined smooth to ensure retention of the axle and wheel.

In addition to the two side passageways 74a, 74b, a smaller central liquid flow passageway 74c is drilled from central recess 76 completely through to the zone immediately behind wheel 34. In use, water (or other liquid) passes down this passageway and emerges behind wheel 34 as a small jet issuing into the limited clearance between the housing and the wheel in order to clear away any debris that might otherwise enter the clearance and jam the wheel, so impeding the free, rolling contact between the wheel and the vessel walls.

To achieve maximum foulant removal, the configuration of the tool head may be altered to address different zones in the snout, gas pipe, cyclone, and dipleg. Since the angle of water jet impingement is different in the snout, gas pipe, cyclone body, and dipleg, each of these zones may require a different combination of nozzle jet angle, orifice size, and elongated spacer member to maximize efficiency of foulant removal. The cleaning tool head must be fully retracted to change the configuration for each of the different cleaning zones. Prior to withdrawing the cleaning tool head to modify its configuration, multiple traverses may be executed in a target zone.

The present cleaning tool may be used, as described above to clean the cyclones of fluid coker units and, in addition to clean cyclones in FCC units and other process units which are subject to foulant deposition, whether with coke or other foulants. The units need, of course, to be constructed so as to permit the introduction of the cleaning tool head into the cyclone snout to be passed down into the gas outlet pipe, the cyclone barrel and the dipleg, according to the need for cleaning. The tool may also be used for cleaning components of other process units which can be accessed from the outside by means of a suitably disposed access/insertion port; in this way, pipes, conduits, flow passages, receivers, distillation columns, contactors and other vessels may be cleaned effectively.

Additional control over the orientation of the tool head can be achieved by forcing the tool against a partial obstruction in the process vessel, e.g. against the interior walls of the cyclone when trying to enter the cyclone dipleg, until the yield point of the tubing is exceeded and the tubing acquires a permanent set although buckling to the point of flattening the tubing should be avoided for obvious reasons. When the cleaning tool head encounters an obstruction, the operator will note an increase in the driving force, as indicated by the load indication from the load cells on the driving mechanism. The operator can then increase the drive force steadily until a decrease is noted along with a forward movement of the tool head, indicating that the yield point has passed and the tube has taken on a permanent set. This permanent set can then be used to impart directional control to the tool head, enabling it to be directed as required around pipe bends and into cyclone diplegs.

1. A process unit cleaning tool for removing foulants from inside process units, which comprises a metal tube having at its leading end an elongated cylindrical cleaning tool head which has a rolling contact element at its leading end and a rotating jet head, axially displaced on the tool head from the rolling contact element, for forming generally radial jets of foulant removal liquid.

2. A process unit cleaning tool according to claim 1 in which the rolling contact element comprises a roller or wheel.

3. A process unit cleaning tool according to claim 2 in which the rolling contact element comprises a roller or wheel journalled in a head which is rotatable about a central axis of the cleaning tool head.

4. A process unit cleaning tool according to claim 1 in which the nozzle jet head comprises a rotating nozzle head having a plurality of liquid jet nozzle outlets arranged around its circumference to produce a liquid jet array upon emergence of the foulant removal liquid from the jet nozzle outlets.

5. A process unit cleaning tool according to claim 4 in which the rotating nozzle head has two or three jet nozzle outlets.

6. A process unit cleaning tool according to claim 4 in which the jet nozzle outlets are aligned non-radially to induce rotation of the nozzle head upon operation.

7. A process unit cleaning tool according to claim 4 in which the jet nozzle outlets are adapted to produce liquid jets of different flow rates to induce imbalance upon operation.

8. A process unit cleaning tool according to claim 4 in which the jet nozzle outlets are arranged at different angles relative to the longitudinal axis of the nozzle member to induce imbalance upon operation.

9. A process unit cleaning tool according to claim 4 in which the jet nozzle outlets are arranged at different radial angles to induce imbalance upon operation.

10. A process unit cleaning tool according to claim 1 in which the rolling contact element is axially displaced from the rotating nozzle head by means of an elongated spacer member.

11. A process unit cleaning tool according to claim 1 in which the leading end of the tool head has a plurality of generally axial, forwardly-oriented liquid jet nozzle outlets adjacent the rolling contact element for foulant removal.

12. A process unit cleaning tool according to claim 11 in which the leading end of the tool head comprises a housing for the roller or wheel rolling contact element and having a limited clearance between the housing and the roller or wheel and a liquid jet nozzle issuing into the limited clearance to maintain cleanliness between the housing and the roller or wheel.

13. A process unit cleaning tool according to claim 1 which includes in the tool head a viscous governor for controlling the rotational rate of the nozzle head in operation.

14. A process unit cleaning tool according to claim 13 which includes a cooling jacket to maintain the tool head viscous governor fluid at an acceptable temperature.

15. A process vessel cleaning system for removing foulants from inside a process vessel, which comprises:
(i) a metal tube,
(ii) a tubing drive unit for advancing the tube into the interior of the process vessel by way of an insertion port and sealing assembly,
(iii) an elongated cylindrical cleaning tool head secured at one end to the leading end of the tube, the tool head comprising (a) a rolling contact element at the leading end of the tool head remote from the end secured to the tube and (b) a rotary jet head, axially displaced on the tool head from the rolling contact element, for forming jets of foulant removal liquid.

16. A process unit cleaning system according to claim 15 in which the tube drive unit comprises a pair of opposed, driven chains with gripper blocks located outside the process vessel, engaging the tube.

17. A process unit cleaning system according to claim 15 in which the tube drive unit comprises a load cell to monitor the drive force exerted on the tube.

18. A process unit cleaning system according to claim 15 in which the tube drive unit comprises at lest one mandrel for imparting a permanent deformation on the metal tube.

19. A process unit cleaning system according to claim 15 in which the rolling contact element comprises a roller or wheel journalled in the cleaning tool head

20. A process unit cleaning system according to claim 15 in which the rotary jet head comprises a rotary nozzle head having a plurality of generally radial liquid jet nozzle outlets arranged around its circumference to produce a liquid jet array upon emergence of the foulant removal liquid from the jet nozzle outlets and induce rotation of the nozzle head.

21. A process unit cleaning tool according to claim 15 in which the leading end of the tool head has a plurality of generally axial, forwardly-oriented liquid jet nozzle outlets adjacent the rolling contact element for foulant removal.

22. A process unit cleaning tool according to claim 21 in which the leading end of the tool head comprises a housing for the roller or wheel rolling contact element and having a limited clearance between the housing and the roller or wheel and a liquid jet nozzle issuing into the limited clearance to maintain cleanliness between the housing and the roller or wheel.

23. A method for cleaning the interior of a process vessel from the outside of the vessel while the vessel is in operation, comprising:
(i) introducing a metal tube into the interior of the process vessel by way of an insertion port and sealing assembly in an exterior wall of the process unit,
(ii) supplying liquid under pressure through the tubing to an elongated cylindrical cleaning tool head secured at one end to the leading end of the tube, the tool head comprising (a) a rolling contact element at the leading end of the tool head remote from the end secured to the tube and (b) a rotary jet head, axially displaced on the tool head from the rolling contact element, to form jets of foulant removal liquid,
(iii) advancing the tool head through the interior of the portions of the process vessel to be cleaned.

24. A method of cleaning the interior of a process vessel according to claim 23 in which the tool head is advanced by means of a tubing drive unit which comprises a pair of opposed, driven chains with gripper blocks located outside the process vessel, engaging the tube.

25. A method of cleaning the interior of a process vessel according to claim 24 which includes the step of monitoring the drive force applied to the tube by means of the driven chains with gripper blocks.

26. A method of cleaning the interior of a process vessel according to claim 23 in which the liquid is supplied under a pressure from 500 to 1000 barg.

27. A method of cleaning the interior of a process vessel according to claim 23 in which the portions of the process vessel to be cleaned comprise at the least the gas outlet conduit of a cyclone.

28. A method of cleaning the interior of a process vessel according to claim 23 in which individual zones of the cyclone system are cleaned with a unique cleaning tool head for each zone.

29. A method of cleaning the interior of a process vessel including constricted equipment openings which comprises
(i) introducing a metal tube into the interior of the process vessel by way of an insertion port and sealing assembly in an exterior wall of the process unit,
(ii) supplying liquid under pressure through the tube to an elongated cylindrical cleaning tool head secured at one end to the leading end of the tube,
(iii) advancing the tool head through the interior of the portions of the process vessel to be cleaned by means of driving force applied at the insertion port and sealing assembly,
(iv) forcibly advancing the metal tube when the cleaning head encounters a change in direction within the conduit until the yield point of the tubing is passed to impart a permanent set to the tubing.

30. A method according to claim 29 in which directional control is imparted to the tool head by imparting a curvature to the tubing at the insertion port and sealing assembly.
